(19) United States
(12) Patent Application Publication
(10) Pub. No.: US 2006/0164942 A1
(43) Pub. Date: Jul. 27, 2006

(54) Method and apparatus for determining type information of recording medium, and method and apparatus for recording/reproducing data in/from the recording medium

(76) Inventors: Jea Yong Yoo, Seoul (KR); Soung Hyun Um, Anyang-si (KR); Wae Yeul Kim, Anyang-si (KR); Byung Jin Kim, Seongnam-si (KR)

Correspondence Address: HARNESS, DICKEY & PIERCE, P.L.C., P.O. BOX 8910, RESTON, VA, 20195, US

(21) Appl. No.: 11/332,311

(22) Filed: Jan. 17, 2006

(30) Foreign Application Priority Data
Jan. 24, 2005 (KR) 10-2005-0006268

(51) Int. Cl. G11B 5/09

(52) U.S. Cl. 369/53.2; 369/47.1

(57) ABSTRACT

A method for determining type information of a recording medium, and a method and apparatus for recording/reproducing data in/from the recording medium using the method are disclosed. The method for determining the type information of the recording medium includes the steps of: a) determining type information of a recording medium classified according to position information of a recording layer contained in the recording medium; and b) determining type information of at least two recording mediums having the same recording layer position on the basis of a reflection signal received via a track cross operation. Therefore, the method can be applied to a fabrication process of a new optical recording/reproducing device for a high-density recording medium, and can effectively record/reproduce data in/from the recording medium.

This application claims the benefit of Korean Patent Application No. 10-2005-0006268, filed on Jan. 24, 2005, which is hereby incorporated by reference as if fully set forth herein.

### BACKGROUND OF THE INVENTION

1. Field of the Invention

The present invention relates to a method for determining type information of a recording medium, and a method and apparatus for recording/reproducing data in/from the recording medium using the method for determining the type information of the recording medium.

2. Discussion of the Related Art

Generally, there has been widely used an optical disc acting as a recording medium capable of recording a large amount of data therein. Particularly, there has recently been developed a high-density optical recording medium capable of recording/storing high-quality video data and high-quality audio data for a long period of time, for example, a High Density DVD (HD-DVD).

The HD-DVD based on the next-generation recording medium technique has been considered to be the next-generation optical recording solution capable of storing much more data than a conventional DVD. In recent times, many developers have conducted intensive research into the international standard technical specification associated with the HD-DVD along with those of other digital devices.

However, although the optical recording/reproducing device must firstly determine whether a recording medium loaded in the optical recording/reproducing device is indicative of the HD-DVD when recording/reproducing data in/from the aforementioned next-generation recording medium such as the HD-DVD, a method for determining type information of the recording medium has not yet been established, such that many limitations and problems occur in developing the high-density optical recording/reproducing device.

### SUMMARY OF THE INVENTION

Accordingly, the present invention is directed to a method for determining type information of a recording medium, and a method and apparatus for recording/reproducing data in/from the recording medium using the method for determining the type information of the recording medium, that substantially obviate one or more problems due to limitations and disadvantages of the related art.

An object of the present invention is to provide a method for determining type information of a variety of recording mediums, and a method and apparatus for recording/reproducing data in/from the recording medium using the method for determining the type information of the recording medium.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for determining type information of a recording medium comprises the steps of: a) determining type information of a recording medium classified according to position information of a recording layer contained in the recording medium via a vertical movement operation of a pickup unit; and b) determining type information of at least two recording mediums having the same recording layer position on the basis of a reflection signal received via a track cross operation.

In another aspect of the present invention, there is provided a method for determining type information of a recording medium comprising the steps of: a) receiving a reflection signal from a loaded recording medium via a track cross operation at a predetermined pickup position; and b) determining type information of the loaded recording medium on the basis of the received reflection signal.

In yet another aspect of the present invention, there is provided a method for recording/reproducing data in/from a recording medium comprising the steps of: a) if the recording medium is loaded, determining type information of a recording medium classified according to position information of a recording layer contained in the recording medium via a vertical movement operation of a pickup unit, and determining type information of at least two recording mediums having the same recording layer position on the basis of a reflection signal received via a track cross operation; and b) initially establishing a system suitable for recording/reproducing operations of the determined recording medium, and performing the recording/reproducing operations using the established system.

In yet another aspect of the present invention, there is provided an apparatus for recording/reproducing data in/from a recording medium comprising: a pickup unit for recording data in the recording medium using an optical beam, and reading data from the recording medium using the optical beam; and a microprocessor for determining type information of the recording medium classified according to position information of a recording layer contained in the recording medium via a vertical movement operation of the pickup unit, determining type information of at least two recording mediums having the same recording layer position on the basis of a reflection signal received via a track cross operation, initially establishing a systems suitable for recording/reproducing operations of the determined recording medium, and performing the recording/reproducing operations using the established system.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A˜1C show characteristics of general recording mediums;

FIGS. 2A˜2C shows pits formed on record tracks of individual recording mediums;

FIG. 3 is a block diagram illustrating an apparatus for recording/reproducing data in/from a recording medium according to the present invention;

FIG. 4A is a flow chart illustrating a method for determining type information of a recording medium in accordance with a first preferred embodiment of the present invention;

FIG. 4B is a flow chart illustrating a method for determining type information of a recording medium in accordance with a second preferred embodiment of the present invention;

FIG. 4C is a flow chart illustrating a method for determining type information of a recording medium in accordance with a third preferred embodiment of the present invention;

FIGS. 5˜7 show signal characteristics for explaining a method for determining type information of a recording medium according to the present invention; and

FIG. 8 is a flow chart illustrating a method for determining a single-layered structure or a dual-layered structure for use in the method for determining the type information of the recording medium according to the first to third preferred embodiments of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A method for determining type information of a recording medium according to the present invention will hereinafter be described with reference to the annexed drawings.

Prior to describing the present invention, it should be noted that most terms disclosed in the present invention correspond to general terms well known in the art, but some terms have been selected by the applicant as necessary and will hereinafter be disclosed in the following description of the present invention. Therefore, it is preferable that the terms defined by the applicant be understood on the basis of their meanings in the present invention.

A recording medium for use in the present invention is indicative of all recordable mediums such as an optical disc for recording/reproducing data upon receiving an optical beam, for example, a Compact Disc (CD), a DVD, and a HD-DVD, etc.

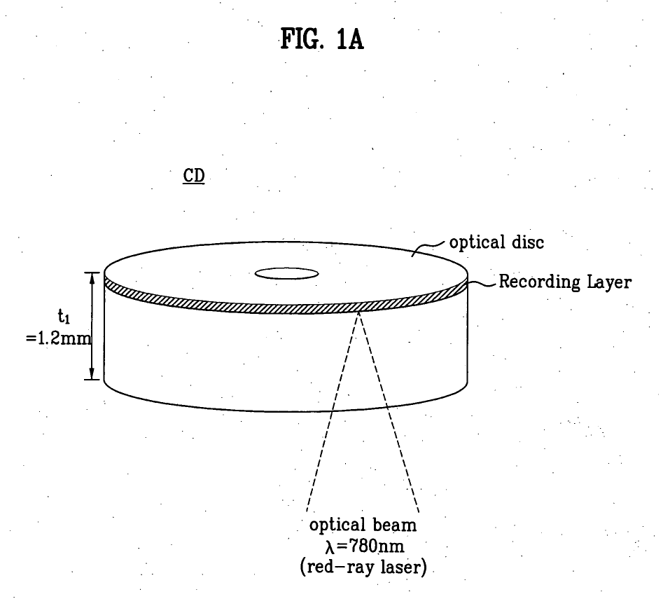

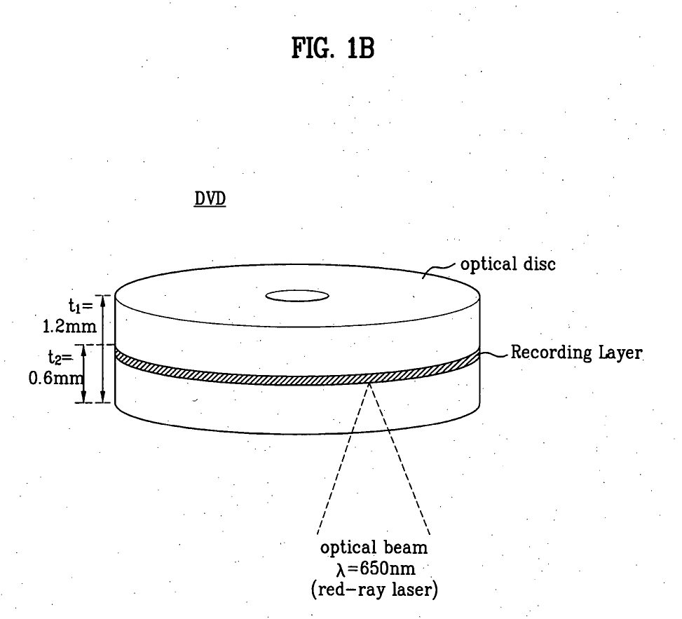

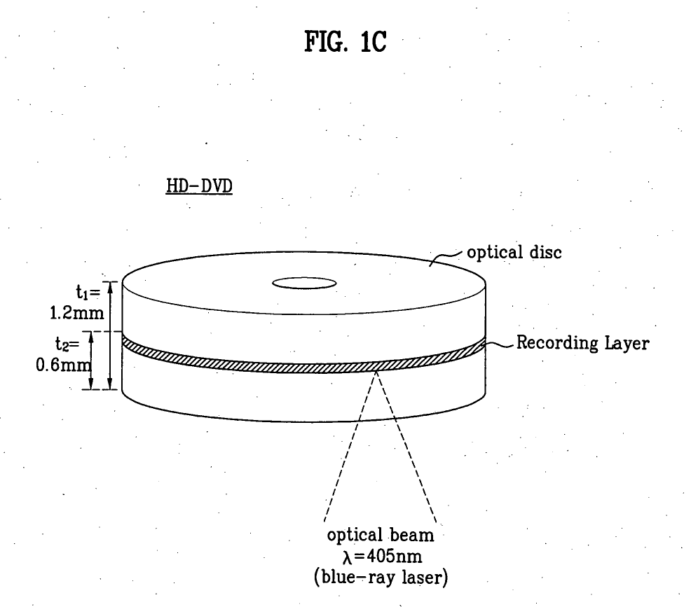

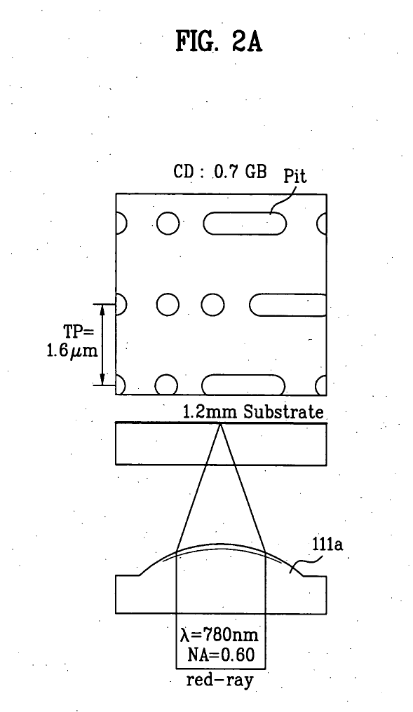

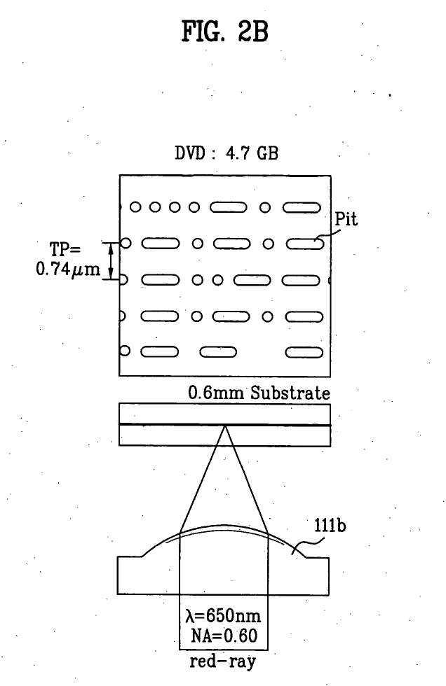

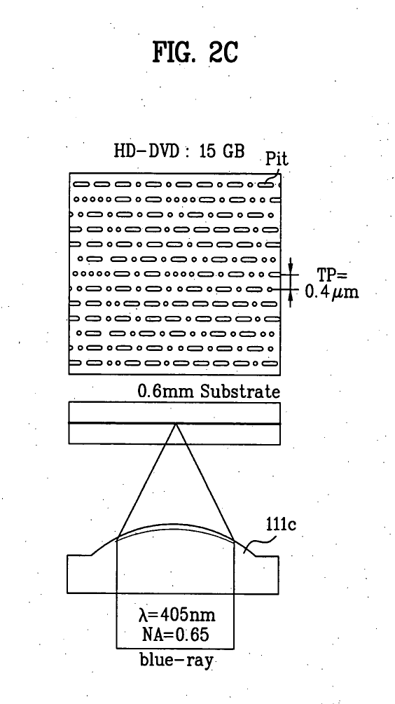

FIGS. 1A˜1C and FIGS. 2A˜2C show a variety of recording mediums according to the present invention. Particularly, FIGS. 1a˜1c and FIGS. 2a˜2c show characteristics of a CD, a DVD, and a HD-DVD. In association with the above-mentioned description, each disc (i.e., CD, DVD, or HD-DVD) has a thickness t1 of 1.2 mm and a diameter of 120 mm.

FIG. 1A shows a cross-sectional view illustrating the CD for the convenience of description. Referring to FIG. 1A, a recording layer contained in the CD is maximally spaced apart from an optical beam direction. Generally, the recording layer has the same thickness as the disc thickness t1 of 1.2 mm. Also, the CD uses a Red-Ray optical beam having a wavelength λ of 780 nm.

FIG. 1B shows a cross-sectional view illustrating the DVD for the convenience of description. Referring to FIG. 1B, a recording layer contained in the DVD is located at the center part on the basis of the optical beam direction. Generally, a specific position t2 is denoted by “t2=0.6 mm”, and is located at the center part of a total disc thickness t1 of 1.2 mm. More particularly, a recording layer having a thickness t2 of 0.6 mm is formed, and a substrate having the same size and thickness as those of the recording layer is deposited on the recording layer, such that the DVD is formed. The DVD uses a Red-Ray optical beam having a wavelength λ of 650 nm.

FIG. 1C shows a cross-sectional view illustrating the HD-DVD for the convenience of description. Referring to FIG. 1C, a recording layer contained in the HD-DVD is located at the center part on the basis of the optical beam direction. Generally, a specific position t2 is denoted by “t2=0.6 mm”, and is located at the center part of a total disc thickness t1 of 1.2 mm. More particularly, similar to the DVD shown in FIG. 1B, a recording layer having a thickness t2 of 0.6 mm is formed, and a substrate having the same size and thickness as those of the recording layer is deposited on the recording layer, such that the HD-DVD is formed. The HD-DVD uses a blue-ray optical beam having a wavelength λ of 405 nm, differently from the DVD shown in FIG. 1B.

FIGS. 2A˜2C show a relationship between an optical beam and pits formed in the recording layer contained in each of the CD, the DVD, and the HD-DVD.

FIG. 2A shows a plan view of pits shown in the recording layer contained in the CD having a recording capacity of about 0.7 GB. Referring to FIG. 2A, if a Red-Ray optical beam having a wavelength λ of 780 nm is illuminated on a recording layer having a thickness of 1.2 mm via an objective lenses 111a having a specific NA (Numerical Aperture) of 0.45 in a pickup unit 11 shown in FIG. 3, pits each of which has a predetermined shape are formed. In this case, a distance between tracks on which the pits are formed is referred to as a TP (Track Pitch), and it can be recognized that the TP is set to 1.6 μm according to the present invention.

FIG. 2B shows a plan view of pits shown in the recording layer contained in the DVD having a recording capacity of about 4.7 GB. Referring to FIG. 2B, if a Red-Ray optical beam having a wavelength λ of 650 nm is illuminated on a recording layer having a thickness of 0.6 mm via an objective lenses 111b having a specific NA of 0.60 in a pickup unit 11 shown in FIG. 3, pits each of which has a predetermined shape are formed. In this case, a distance between tracks on which the pits are formed is referred to as a TP, and it can be recognized that the TP is set to 0.74 μm according to the present invention.

FIG. 2C shows a plan view of pits shown in the recording layer contained in the HD-DVD having a recording capacity of about 15 GB. Referring to FIG. 2C, if a Blue-Ray optical beam having a wavelength λ of 405 nm is illuminated on a recording layer having a thickness of 0.6 mm via an objective lenses 111c having a specific NA of 0.65 in a pickup unit 11 shown in FIG. 3, pits each of which has a predetermined shape are formed. In this case, a distance between tracks on which the pits are formed is referred to as a TP, and it can be recognized that the TP is set to 0.4 μm according to the present invention.

In association with the above-mentioned description, a plurality of objective lenses 111a, 111b, and 111c, each of which has a specific NA, in the pickup unit 11 of FIG. 3 may be composed of different objective lenses, or may be composed of a single objective lens. Otherwise, the objective lenses 111a and 111b are composed of a single objective lens, and the objective lens 111c is composed of another objective lens different from the single objective lens. In other words, the objective lens configuration of the present invention can be determined in various ways.

In more detail, referring to FIGS. 1A˜1C and FIGS. 2A˜2C, it can be recognized that a recording layer of the CD is arranged at a specific location different from those of individual recording layers of the DVD and the HD-DVD, and the CD has a longer distance between pits and a longer distance between TPs as compared to the DVD and the HD-DVD. Although the recording layer of the DVD is arranged at the same location as that of the HD-DVD, the DVD has a longer distance between pits and a longer distance between TPs as compared to the HD-DVD.

Therefore, it is obvious to those skilled in the art that system environments for recording/reproducing data in/from the aforementioned CD, DVD, and HD-DVD are different from each other. If any one of the CD, DVD, and HD-DVD is loaded in the optical recording/reproducing device, the optical recording/reproducing device must firstly determine type information of the loaded disc, must initially establish a unique system environment for the loaded disc on the basis of the determined type information, and must perform appropriate data recording/reproducing operations.

A method and apparatus for determining type information of a recording medium (e.g., CD, DVD, or HD-DVD), and a method and apparatus for determining recording/reproducing data in/from the recording medium according to the determined type information will hereinafter be described with reference to FIGS. 3 to 7.

FIG. 3 is a block diagram illustrating the optical recording/reproducing device according to the present invention.

Referring to FIG. 3, the optical recording/reproducing device includes a recording/reproducing unit 20 for recording/reproducing data in/from the optical disc and a controller 12 for controlling the recording/reproducing unit 20.

The recording/reproducing unit 20 includes a pickup unit 11, a signal processor 13, a servo unit 14, a memory 15, and a microprocessor 16. The pickup unit 11 directly records data in the optical disc, or reads data from the optical disc. The signal processor 13 receives a signal read from the pickup unit 11, restores the received signal to a desired signal value, or modulates a signal to be recorded into another signal recorded in the optical disc, such that it transmits the restored or modulated result. The servo unit 14 accurately reads a desired signal from the optical disc, or controls the pickup unit 11 to accurately record a signal in the optical disc. The memory 15 temporarily stores disc management information and data therein. The microprocessor 16 controls operations of the above-mentioned components. In association with the above-mentioned description, an optical recording/reproducing unit composed of only the recording/reproducing unit 20 is referred to as a drive, and is applicable to computer peripheral devices.

In association with the above-mentioned description, it is well known to those skilled in the art that the pickup unit 11 includes an optical-beam output unit, an objective lens for illuminating the output optical beam on a disc record layer, and a photo-detector for receiving a signal reflected from the disc, etc.

The controller 12 controls the aforementioned constituent components. Particularly, the controller 12 receives a user command via a user interface, and transmits a record/reproduction commands for recording/reproducing data in/from the optical disc to the aforementioned recording/reproducing unit 20 according to the received user command.

A decoder 17 finally decodes the signal read from the optical disc upon receiving a control signal from the controller 12, and provides the user with the decoded result.

An encoder 18 converts an input signal into a specific format signal (e.g., an MPEG2 transport stream) upon receiving a control signal from the controller 12, and transmits the converted result to the signal processor 13, such that a desired signal can be recorded in the optical disc.

In order to perform the record/reproduction commands via the controller, the recording/reproducing unit 20 must determine type information of the disc loaded in the optical recording/reproducing device, and must transmit the determined type information to the controller 12.

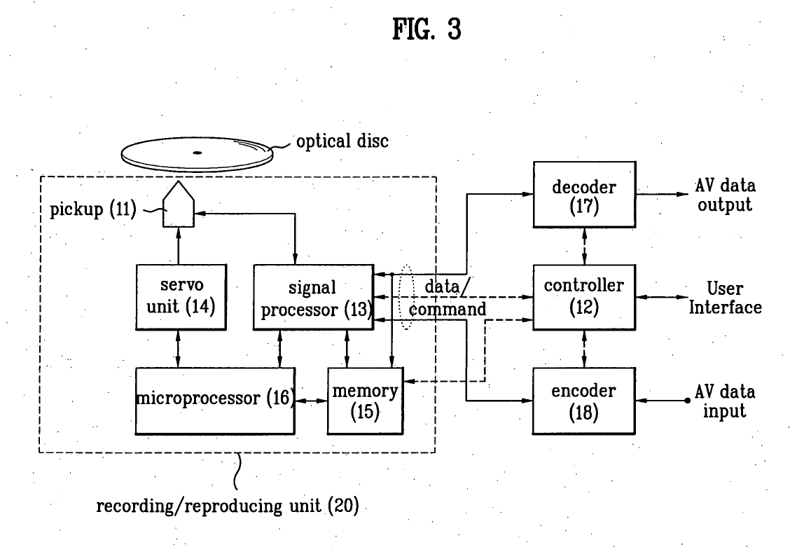

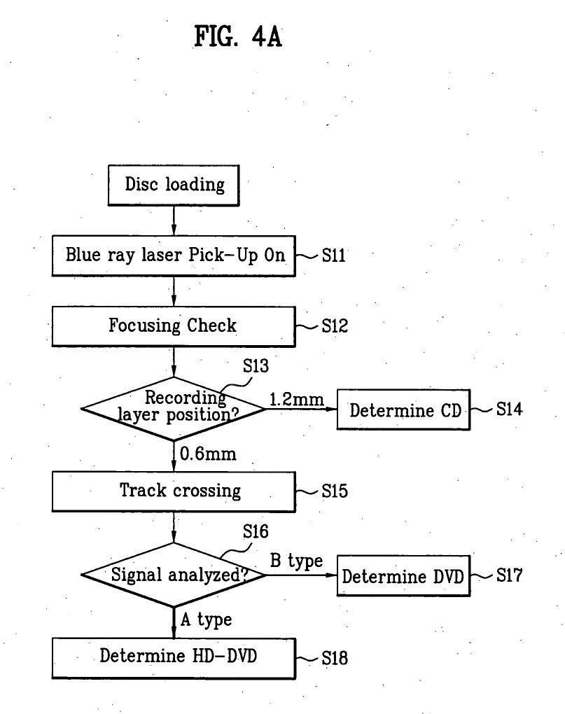

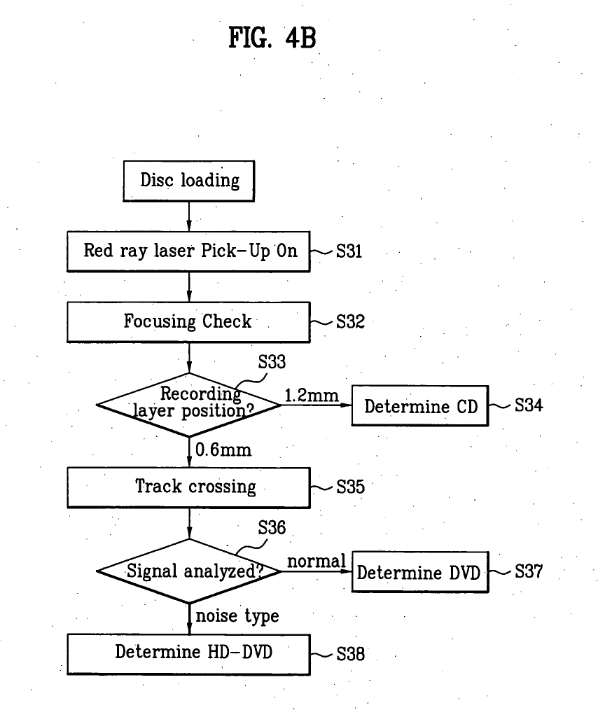

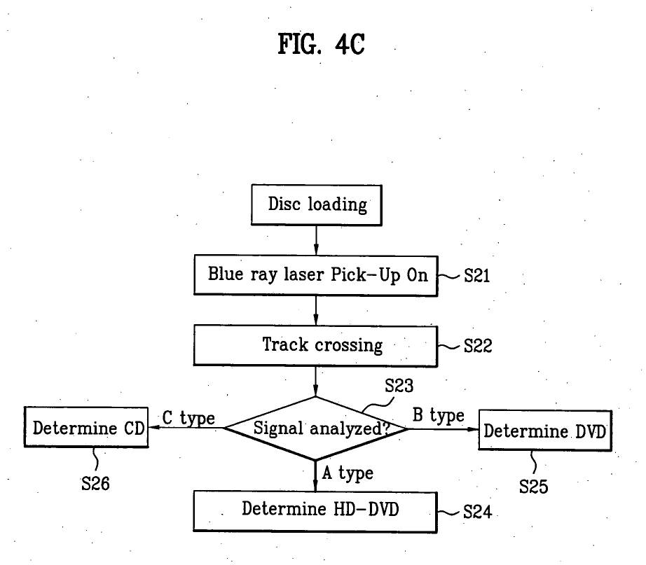

A method for determining type information of a recording medium using the aforementioned optical recording/reproducing device will hereinafter be described with reference to FIGS. 4A˜7.

FIG. 4A is a flow chart illustrating a method for determining type information of a recording medium in accordance with a first preferred embodiment of the present invention.

Referring to FIG. 4A, the method for determining type information of the recording medium according to the first preferred embodiment is characterized in that it firstly determines type information of the recording medium according to recording layer position information of the recording medium, determines type information of at least two recording mediums having the same recording layer position on the basis of a reflection signal received via a track cross, and uses a Blue-ray optical beam to determine type information of the recording medium.

For example, if an optical disc is loaded in the optical recording/reproducing device, the microprocessor 16 switches on the pickup unit 11 using the Blue-ray optical beam at step S11, and allows the servo unit 14 to perform a focusing operation by which the pickup unit 11 moves up and down at step S12.

A recording layer position at which a signal is normally detected can be recognized by the aforementioned focusing operation at step S13. If the recording layer position at which the signal is normally received is determined to be 1.2 mm, the loaded disc is determined to be the CD at step S14. If the recording layer position at which the signal is normally received is determined to be 0.6 mm, the loaded disc is determined to be the DVD or the HD-DVD.

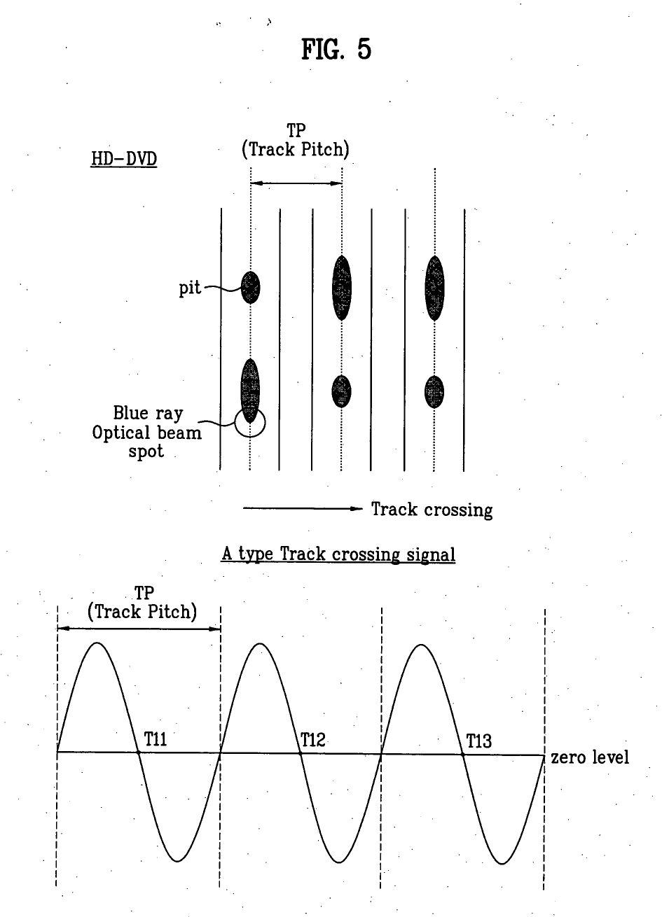

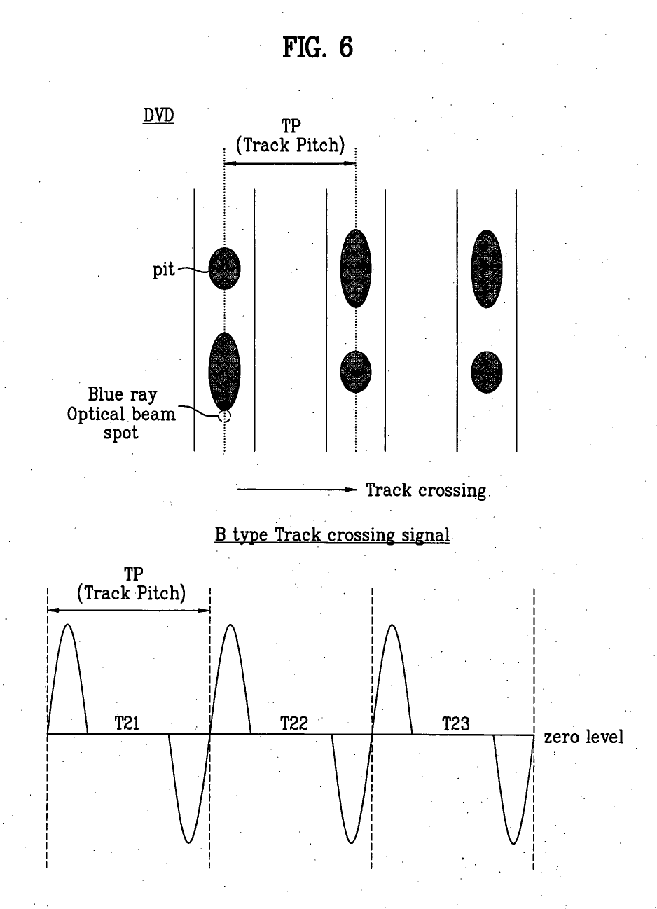

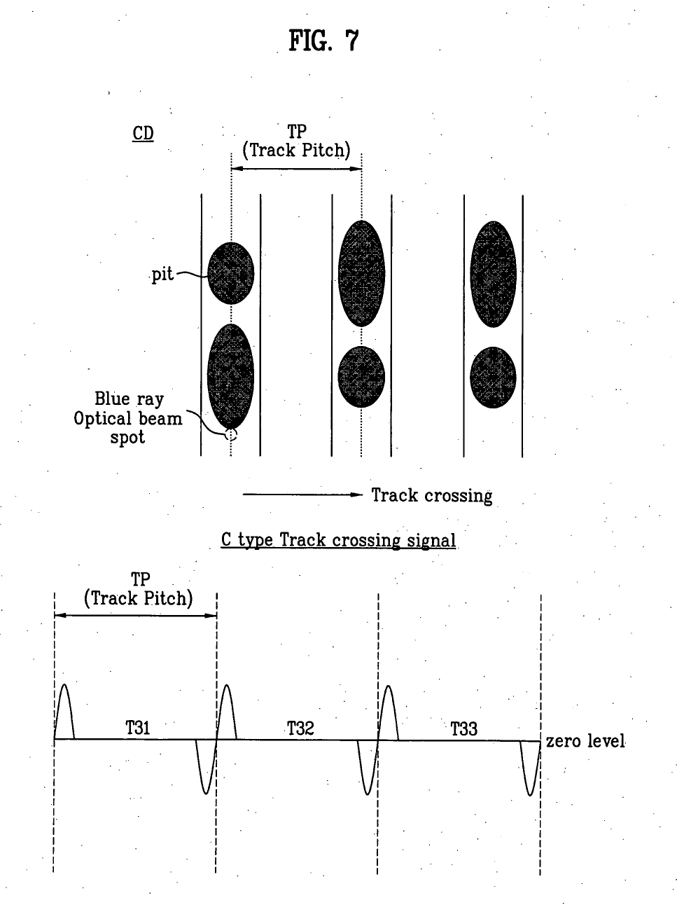

As previously stated in FIGS. 2A˜2C, the DVD and the HD-DVD have different TPs, such that the DVD or the HD-DVD can be determined on the basis of a reflection signal received via the track crossing operation (shown in step S15) at step S16. In more detail, if the reflection signal received via the track cross of step S15 has a waveform diagram shown in FIG. 5 (hereinafter referred to as an “A-type” signal), the loaded disc is determined to be the HD-DVD at step S18. If the reflection signal has a waveform diagram shown in FIG. 6 (hereinafter referred to as a “B-type” signal), the loaded disc is determined to be the DVD at step S17.

In association with the above-mentioned description, the reflection signal received via the track cross is acquired by the sum of all signals (also called a “read channel”) reflected from the disc on which the optical beam was illuminated. The reflection signal is normally detected from a track interval including pits, but it is not normally detected from another interval including no pits.

Therefore, all signals of the “A-type” disc determined to be the HD-DVD have normal waveform curves as shown in FIG. 5, because a blue-ray optical beam capable of determining the HD-DVD is suitable for pits and TPs formed in the recording layer of the HD-DVD. In other words, a single zero-level interval T11, T12, or T13 exists in a single TP interval, such that three zero-level intervals T11, T12, and T13 associated with three TP intervals are depicted in FIG. 5. The crossing of the blue-ray optical beam in a specific interval having no pits is executed at individual zero-level intervals T11, T12, and T13.

On the other hand, all signals of the “B-type” disc determined to be the DVD do not have normal waveform curves as shown in FIG. 6. A single zero-level interval T21, T22, or T23 exists in a single TP interval, such that three zero-level intervals T21, T22, and T23 associated with three TP intervals are depicted in FIG. 6. The reason why the zero-level intervals T21, T22, and T23 occur is that a blue-ray optical beam capable of determining the DVD is improper for pits and TPs formed in the recording layer of the DVD. In more detail, the TP interval is wider than the Blue-ray optical beam interval, such that the aforementioned zero-level intervals T21, T22, and T23 occur while the crossing of the Blue-ray optical beam is executed in a specific interval having no pits.

Therefore, according to the first preferred embodiment of the present invention, the CD is determined on the basis of the position of a recording layer, and the DVD or the HD-DVD can be determined on the basis of a track-cross reflection signal using a blue-ray optical beam. According to the aforementioned determination result, the microprocessor 16 establishes initial environments (e.g., an optical beam to be used, a pickup objective lens, and a signal modulation method, etc.) as a system suitable for the determined disc, and performs recording/reproducing operations upon receiving the record/reproduction commands from the controller 12.

FIG. 4B is a flow chart illustrating a method for determining type information of a recording medium in accordance with a second preferred embodiment of the present invention.

Referring to FIG. 4B, the method for determining type information of the recording medium according to the second preferred embodiment is characterized in that it firstly determines type information of the recording medium according to recording layer position information of the recording medium, determines type information of at least two recording mediums having the same recording layer position on the basis of a reflection signal received via a track cross, and uses a Red-ray optical beam to determine type information of the recording medium. In other words, compared with the first preferred embodiment of FIG. 4B, the second preferred embodiment shown in FIG. 4B uses the Red-ray optical beam instead of the Blue-ray optical beam of FIG. 4A.

For example, if an optical disc is loaded in the optical recording/reproducing device, the microprocessor 16 switches on the pickup unit 11 using the Red-ray optical beam at step S31, and allows the servo unit 14 to perform a focusing operation by which the pickup unit 11 moves up and down at step S32.

A recording layer position at which a signal is normally detected can be recognized by the aforementioned focusing operation at step S33. If the recording layer position at which the signal is normally received is determined to be 1.2 mm, the loaded disc is determined to be the CD at step S34. If the recording layer position at which the signal is normally received is determined to be 0.6 mm, the loaded disc is determined to be the DVD or the HD-DVD.

As previously stated in FIGS. 2A˜2C, the DVD and the HD-DVD have different TPs, such that the DVD or the HD-DVD can be determined on the basis of a reflection signal received via the track crossing operation (shown in step S35) at step S36. In more detail, if the reflection signal received via the track cross of step S35 is normally detected, the loaded disc is determined to be the DVD at step S37. If the reflection signal is a meaningless signal such as noise, the loaded disc is determined to be the HD-DVD at step S38.

In the case of the DVD, the red-ray optical beam used for determining the DVD is suitable for pits and TP intervals formed in the recording layer of the DVD, such that a normal signal will be detected as shown in the A-type signal of FIG. 5. In the case of the HD-DVD, the red-ray optical beam used for determining the HD-DVD is relatively very large as compared to pits and TP intervals formed in the recording layer of the HD-DVD, such that a noise signal incapable of forming a predetermined pattern is detected. In brief, a peak-to-peak value of the noise signal is considerably lower than that of a normal signal.

Therefore, according to the second preferred embodiment of the present invention, the CD is determined on the basis of the position of a recording layer, and the DVD or the HD-DVD can be determined on the basis of a track-cross reflection signal using a Red-ray optical beam.

FIG. 4C is a flow chart illustrating a method for determining type information of a recording medium in accordance with a third preferred embodiment of the present invention.

Referring to FIG. 4C, the method for determining type information of the recording medium according to the third preferred embodiment is characterized in that it receives a reflection signal from the loaded recording medium via a track crossing operation at a predetermined pickup position, and determines type information of the loaded recording medium on the basis of the received reflection signal. In other words, compared with the first and second preferred embodiments of FIGS. 4A˜4B, the third preferred embodiment shown in FIG. 4C omits the process for determining disc type information via a focusing operation, and directly determines the disc type information via a track cross operation. In association with the above-mentioned description, the optical beam used for determining type information of the recording medium is exemplarily set to the blue-ray optical beam for the convenience of description.

For example, if an optical disc is loaded in the optical recording/reproducing device, the microprocessor 16 switches on the pickup unit 11 using the Blue-ray optical beam at step S21, moves the pickup unit 11 to a predetermined position, and performs a track crossing operation at the predetermined position at step S22. In association with the above-mentioned description, the predetermined position of the pickup unit may be pre-set to a specific value when a system is manufactured. However, if the system is determined to be the optical recording/reproducing device capable of recording/reproducing data in/from the HD-DVD, there may be pre-established a preferred pickup position at which data of a disc having a recording layer position of 0.6 mm can be recorded/reproduced.

If a reflection signal received via the track cross at step S22 is determined to be the A-type signal shown in FIG. 5, the loaded disc is determined to be the HD-DVD at step S24. If a reflection signal received via the track cross at step S22 is determined to be the B-type signal shown in FIG. 6, the loaded disc is determined to be the DVD at step S25. If a reflection signal received via the track cross at step S22 is determined to be the C-type signal shown in FIG. 7, the loaded disc is determined to be the CD at step S26.

In association with the above-mentioned description, the aforementioned A-type signal of FIG. 5 and the aforementioned B-type signal of FIG. 6 are equal to that of the first preferred embodiment. However, the third preferred embodiment is designed not to perform the initial focusing process, such that a real amplitude of a detected reflection signal in the third preferred embodiment may be less than that of the first preferred embodiment.

In addition, all signals of the C-type signal determined to be the CD do not have normal waveform curves as shown in FIG. 7, and a single zero-level interval T31, T32, or T33 exists in a single TP interval. The reason why the three zero-level intervals T31, T32, and T33 occur is that a blue-ray optical beam capable of determining the CD is improper for pits and TPs formed in the recording layer of the CD. Specifically, the zero-level intervals T31, T32, and T33 shown in FIG. 7 are almost double that of the zero-level intervals T21, T22, and T23 shown in FIG. 6, because a CD's TP (i.e., 1.6 μm) is wider than a DVD's TP (i.e., 0.74 μm) by about two times or more. Therefore, if the length of the aforementioned zero-level interval is checked, the CD or the DVD can be determined.

Moreover, if the aforementioned zero-level intervals T21˜T23 or T31˜T33 are detected, the focusing operation is executed by the vertical movement of the pickup unit so as to more correctly identify the CD and the DVD, such that a recording layer position can be determined according to the focusing operation result. In other words, if the recording layer position is determined to be 1.2 mm, the disc is determined to be a CD. If the recording layer position is determined to be 0.6 mm, the disc is determined to be a DVD.

Therefore, according to the third preferred embodiment of the present invention, the CD, the DVD, and the HD-DVD can be determined on the basis of the track-cross reflection signal using the blue-ray optical beam. According to the aforementioned determination result, the microprocessor 16 establishes initial environments (e.g., an optical beam to be used, a pickup objective lens, and a signal modulation method, etc.) as a system suitable for the determined disc, and performs recording/reproducing operations upon receiving the record/reproduction commands from the controller 12.

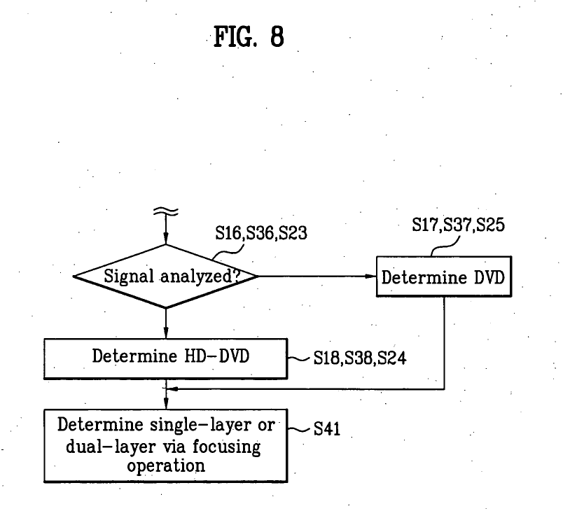

FIG. 8 is a flow chart illustrating a method for determining a single-layered structure or a dual-layered structure for use in the method for determining the type information of the recording medium according to the first to third preferred embodiments of the present invention.

Referring to FIG. 8, signal analysis steps S16, S36, and S23 are applied to a disc loaded in the optical recording/reproducing device, such that the loaded disc is determined to be the DVD at steps S17, S37, and S25 or is determined to be the HD-DVD at steps S18, S38, and S24. Thereafter, the focusing process is executed to determine the number of recording layers contained in the disc at step S41.

In association with the above-mentioned description, the DVD or the HD-DVD may have a single-layered structure or a dual-layered structure as necessary. Specifically, in the case of a dual-layered DVD or a dual-layered HD-DVD, two recording layers contained in the DVD or the HD-DVD are adjacent to each other, and the presence or absence of the recording layers adjacent to each other can be recognized by the vertical movement (i.e., the focusing operation) of the pickup unit. In more detail, if the pickup unit detects a normal signal via the vertical movement, the presence of the adjacent recording layers is determined. If the pickup unit detects an abnormal signal via the vertical movement, the absence of the adjacent recording layers is determined.

As apparent from the above description, a method for determining type information of a recording medium, and a method and apparatus for recording/reproducing data in/from the recording medium using the method for determining the type information of the recording medium according to the present invention can be applied to a fabrication process of a new optical recording/reproducing device for a high-density recording medium, and can effectively record/reproduce data in/from the recording medium.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for determining type information of a recording medium comprising the steps of:
a) determining type information of a recording medium classified according to position information of a recording layer contained in the recording medium; and
b) determining type information of at least two recording mediums having the same recording layer position on the basis of a reflection signal received via a track cross operation.

2. The method according to claim 1, wherein the recording-medium type information classified according to the recording layer position of the recording medium is indicative of a Compact Disc (CD).

3. The method according to claim 1, wherein the recording mediums classified via the track cross operation because they have the same recording layer position are indicative of a DVD (Digital Versatile Disc) and a HD-DVD (High-Density DVD).

4. The method according to claim 3, wherein the track cross operation is executed by an optical beam, wherein the optical beam is a Blue-ray optical beam.

5. The method according to claim 4, wherein:
if a normal track-cross signal is detected from a specific recording medium during the track cross operation based on the Blue-ray optical beam, the specific recording medium is determined to be the HD-DVD.

6. The method according to claim 4, wherein:
if a track-cross zero-level interval is repeatedly detected from a specific recording medium during the track cross operation based on the Blue-ray optical beam, the specific recording medium is determined to be the DVD.

7. The method according to claim 3, wherein the track cross operation is executed by an optical beam, wherein the optical beam is a Red-ray optical beam.

8. The method according to claim 7, wherein:
if a normal track-cross signal is detected from a specific recording medium during the track cross operation based on the Red-ray optical beam, the specific recording medium is determined to be the DVD.

9. The method according to claim 7, wherein:
if an atypical noise signal is repeatedly detected from a specific recording medium during the track cross operation based on the Red-ray optical beam, the specific recording medium is determined to be the HD-DVD.

10. A method for determining type information of a recording medium comprising the steps of:
a) receiving a reflection signal from a loaded recording medium via a track cross operation at a predetermined pickup position; and
b) determining type information of the loaded recording medium on the basis of the received reflection signal.

11. The method according to claim 10, wherein the track cross operation is executed by an optical beam, wherein the optical beam is a Blue-ray optical beam.

12. The method according to claim 11, wherein:
if a normal track-cross signal is detected from a specific recording medium during the track cross operation, the specific recording medium is determined to be a High-Density Digital Versatile Disc (HD-DVD).

13. The method according to claim 11, wherein:
if a track-cross zero-level interval is repeatedly detected from a specific recording medium during the track cross operation, the specific recording medium is determined to be a Compact Disc (CD) or a DVD (Digital Versatile Disc).

14. The method according to claim 13, wherein:
if the detected track-cross zero-level interval is determined to be first interval lengths T21, T22, and T23 in a specific recording medium, the specific recording medium is determined to be a DVD, and
if second interval lengths T31, T32, and T33 longer than the first interval lengths T21, T22, and T23 are detected from a specific recording medium, the specific recording medium is determined to be a CD.

15. The method according to claim 13, further comprising the step of:
if the track-cross zero-level interval is repeatedly detected from the specific recording medium, performing a vertical movement operation of a pickup unit, and determining whether the specific recording medium is the CD or the DVD according to recording-layer position information of the recording medium.

16. A method for recording/reproducing data in/from a recording medium comprising the steps of:
a) if the recording medium is loaded, determining type information of a recording medium classified according to position information of a recording layer contained in the recording medium, and determining type information of at least two recording mediums having the same recording layer position on the basis of a reflection signal received via a track cross operation; and
b) initially establishing a system suitable for recording/reproducing operations of the determined recording medium, and performing the recording/reproducing operations using the established system.

17. The method according to claim 16, further comprising the step of:
if the loaded disc is determined to be a HD-DVD, initially establishing a system based on a Blue-ray optical beam.

18. An apparatus for recording/reproducing data in/from a recording medium comprising:
a pickup unit for recording data in the recording medium using an optical beam, and reading data from the recording medium using the optical beam; and
a microprocessor for determining type information of the recording medium classified according to position information of a recording layer contained in the recording medium via a vertical movement operation of the pickup unit, determining type information of at least two recording mediums having the same recording layer position on the basis of a reflection signal received via a track cross operation, initially establishing a system suitable for recording/reproducing operations of the determined recording medium, and performing the recording/reproducing operations using the established system.
